(19) United States
(12) Patent Application Publication
(10) Pub. No.: US 2011/0208630 A1
(43) Pub. Date: Aug. 25, 2011

(54) METHODS AND SYSTEMS FOR DETECTION OF FINANCIAL CRIME

(75) Inventor: Gideon Hazzani, Rishon Le Zion (IL)

(73) Assignee: VERINT SYSTEMS LTD., Herzliya Pituach (IL)

(21) Appl. No.: 13/011,870

(22) Filed: Jan. 22, 2011

(30) Foreign Application Priority Data
Jan. 24, 2010 (IL) 203466

(51) Int. Cl. G06Q 40/00

(52) U.S. Cl. 705/35

(57) ABSTRACT

Systems and methods for evaluating financial transactions. Methods include receiving first indications of financial transactions related to a target user from a financial system, and receiving second indications of communication events, which are related to the target user but are not directly related to any financial transactions. Forensic criterion are evaluated defined over the first and second indications to issue and alert upon meeting the criterion. The forensic criterion may include detecting a money laundering event, a fraud event, or a financial transaction that is not related to the target user.

### FIELD OF THE DISCLOSURE

The present disclosure relates generally to data analysis, and particularly to detecting financial crime.

### BACKGROUND OF THE DISCLOSURE

Money laundering typically involves executing a series of transactions designed to disguise an illegal source of financial assets as the proceeds of legitimate activity. The series of transactions enables these assets to be used without compromising the criminals who obtained them. Although financial criminals employ a wide variety of complex financial schemes to launder money, common schemes often include three steps referred to as placement, layering and integration. In the placement step, the launderer deposits illegally-obtained funds into a legitimate financial institution, such as a bank or an insurance company. In the layering step, the launderer converts and/or moves the funds in a series of financial transactions designed to distance the funds from their original source. In the final integration step, the launderer re-introduces the funds into a legitimate economy.

Each of the three steps described above may further comprise a variety of individual activities that involve multiple financial institutions, possibly in a number of countries. Examples of activities include cash transactions, conversion of the funds to monetary instruments, wire transfers, and the use of non-bank based money transmitters. Wire transfer transactions may be made using a variety of mechanisms, such as shell companies, front corporations and false invoicing.

### SUMMARY OF THE DISCLOSURE

An embodiment that is described herein provides a method, including:

receiving from a financial system first indications of financial transactions related to a target user;

receiving from a communication network second indications of communication events, which are related to the target user but are not directly related to any financial transactions;

evaluating in a computer a forensic criterion defined over the first and second indications; and

issuing an alert upon meeting the criterion.

In some embodiments, evaluating the forensic criterion includes detecting a financial crime event using the first and second indications. In an embodiment, the financial crime event includes a money laundering event and/or a fraud event. In a disclosed embodiment, evaluating the forensic criterion includes associating, based on the second indications, the target user with at least one financial transaction that is not related to the target user according to the first indications. In another embodiment, evaluating the forensic criterion includes associating the target user with at least one other user based on the second indications. In yet another embodiment, evaluating the forensic criterion and issuing the alert include constructing, based on the first and second indications, a profile that indicates characteristic financial and communication activity of the target user, and issuing the alert upon detecting a deviation from the profile. In still another embodiment, evaluation of the forensic condition is performed only following a trigger from the financial system indicating a suspected financial event related to the target user.

There is additionally provided, in accordance with an embodiment that is described herein, apparatus, including:

an interface, which is configured to receive from a financial system first indications of financial transactions related to a target user, and to receive from a communication network second indications of communication events that are related to the target user but are not directly related to any financial transactions; and

a processor, which is configured to evaluate a forensic criterion defined over the first and second indications, and to issue an alert upon meeting the criterion.

There is also provided, in accordance with an embodiment that is described herein, a computer software product, including a computer-readable medium, in which program instructions are stored, which instructions, when read by a computer, cause the computer to receive from a financial system first indications of financial transactions related to a target user, to receive from a communication network second indications of communication events that are related to the target user but are not directly related to any financial transactions, to evaluate a forensic criterion defined over the first and second indications, and to issue an alert upon meeting the criterion.

### BRIEF DESCRIPTION OF THE DRAWINGS

The disclosure is herein described, by way of example only, with reference to the accompanying drawings, wherein:

FIG. 1 is a block diagram that schematically illustrates a financial crime detection process, in accordance with an embodiment of the present disclosure;

FIG. 2 is a block diagram that schematically illustrates a financial crime detection system, in accordance with an embodiment of the present disclosure; and

FIG. 3 is a flow diagram that schematically illustrates a method for detecting financial crimes, in accordance with an embodiment of the present disclosure.

### DETAILED DESCRIPTION

### Overview

Money laundering activities are often difficult to detect and track because of the long and complex transaction chains involved. Such transaction chains may traverse multiple financial institutions in different countries, and be performed by multiple individuals, some of whom may be innocent. Moreover, even if a suspicious transaction is detected, it may be difficult to discover evidence that incriminates the parties involved in the money laundering. Other kinds of financial crime, such as fraud, are also difficult to detect and prove based on the information available to financial institutions.

Embodiments of the present disclosure that are described hereinbelow provide improved methods and systems for detecting financial crimes such as money laundering or fraud activities. These methods and systems detect potential financial crimes by analyzing both financial transactions and communication events pertaining to certain target individuals. In some embodiments, a crime detection system accepts from one or more financial institutions indications of financial transactions related to a certain target user. In addition, the system accepts from one or more telecommunication operators indications of communication events related to the target user. Generally, the communication events are not directly related to the financial transactions. In other words, the communication events and the financial transactions are not necessarily performed in time proximity or in geographical proximity to one another.

The system evaluates a forensic criterion defined over both the indications of the financial transactions and the indications of the communication events. If the criterion is met, the system triggers an alert, e.g., to an investigating authority. Since the disclosed techniques analyze finance-related and communication-related information jointly, they are able to detect criminal events that are undetectable using financial or communication analysis alone. Several example scenarios of this sort are described herein. Adding a non-financial source of information presents a more complete activity picture to crime investigators, thereby helping them detect potential crimes and gather the necessary evidence.

In some embodiments, the system constructs a financial profile of the target user based on the financial transactions, and a telecom profile of the target user based on the communication events. The system then produces a hybrid financial-telecom profile of the target user based on the two profiles. In these embodiments, the system evaluates the forensic criterion with respect to the hybrid profile. For example, the system may issue an alert upon detecting a deviation from the communication/financial activity indicated by the hybrid profile.

In some embodiments, the disclosed techniques can be tailored to match different legal and regulatory environments with regard to information privacy. While some countries permit access to mass databases containing personal and historic data, other countries restrict access to such data. Therefore, in some embodiments, the crime detection system gathers and processes financial and communication-related information for all users. Alternatively, the system may gather and process information only for pre-designated target users, e.g., users for which a warrant has been issued.

### Joint Analysis of Financial Transactions and Communication Events

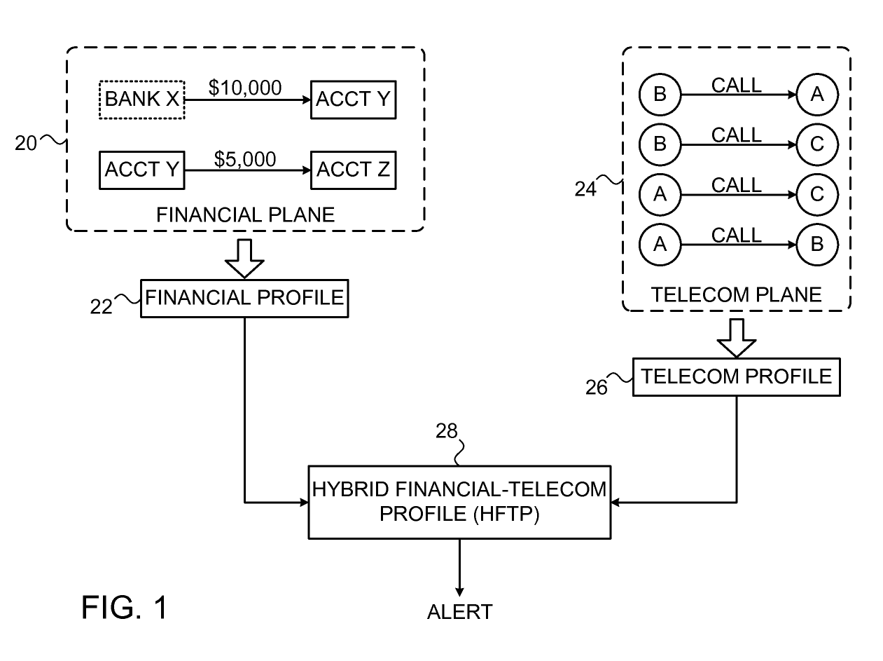

FIG. 1 is a block diagram that schematically illustrates a financial crime detection process, in accordance with an embodiment of the present disclosure. The description that follows refers to a financial plane and a telecom plane. The term “financial plane” refers to information regarding financial transactions, which is obtained from data processing systems of financial institutions. The term “telecom plane” refers to information regarding communication events, such as phone calls or other communication sessions, which is obtained from various communication networks.

In the example process of FIG. 1, indications regarding financial transactions associated with a certain target individual (also referred to as a “target user”) are obtained from a financial plane 20. The indications are processed to produce a financial profile 22 of the target user. Indications regarding communication events associated with this target user are obtained from a telecom Plane 24. These indications are processed to produce a telecom profile 26 of this target user. The financial profile and the telecom profile of the target user are correlated or otherwise processed to produce a Hybrid Financial-Telecom Profile (HFTP) 28 of the target user. The HFTP typically indicates the characteristic financial and communication activity of the target user, and deviations from this profile may indicate a suspicious event. Thus, the HFTP is used for detecting abnormal events or other activities related to the target user that may indicate financial crime. Detecting a suspicious event typically triggers an alert. The communication events used for producing telecom profile 22 are often not directly related to the financial transactions used for producing financial profile 26. Typically, the communication events indicate communication sessions conducted by the target user, regardless of whether he is engaged in financial transactions.

As will be explained below, detecting suspicious events is performed by a rule engine, which holds one or more forensic criteria defined over the indications obtained from the financial and telecom planes. When a given forensic criterion is met, the rule engine initiates an alert. Rules defined to detect forensic criteria can be checked against the HFTP either upon creating the HFTP, or upon any updates to either the financial or telecom profiles. The generated alerts can then be researched by an investigator. The rules applied by the rule engine may be operator-defined (e.g., during initial setup or during operation) or created automatically, e.g., using artificial intelligence techniques.

In the example shown in FIG. 1, the indications provided from financial plane 20 indicate (1) a $10,000 transfer from an account at bank X to an account Y associated with a user B, and a $5,000 transfer from account Y to an account Z associated with a user C. In this example, the user information associated with bank X cannot be accessed directly due to privacy laws of the country where bank X is located.

The indications obtained from telecom plane 24 indicate several communication events, namely user B communicating with a user A, user B communicating with user C, user A communicating with user C, and user A communicating with user B. By analyzing the HFTP (i.e., by analyzing both the indications of financial transactions and the indications of communication events), a direct connection can be detected between users A, B and C. As a result, an alert identifying user A as a suspect “placer” can be triggered. This alert may indicate that the account at bank X may be associated with user A. The analysis of HFTP 28 may identify communication activities (e.g., B calling A) that are not directly related to a financial transaction, but may be a key component to identifying the participants of an illegitimate financial transaction chain. Note that in the present example, analyzing the financial transactions alone, without the communication events, would not enable this detection.

In other words, the process of FIG. 1 demonstrates how the communication events are able to associate a certain user to a financial transaction, which could not be associated with this user based on the indications received from the financial plane. In alternative embodiments, the indications of the communication events can be used to associate the target user with at least one other user. This association may further assist in detecting suspicious events, and is generally impossible using the financial information alone.

Another example of applying the rule engine to HFTP 28 is in detecting fake identities. For example, it may be difficult to detect that user A is using a fake identity and address by solely analyzing his financial transactions. However, by analyzing the HFTP, user A's mobile phone locations habits can be detected. An alert can be generated upon detecting a mismatch between the user's reported home address (from the financial plane) and the detected location habits (from the telecom plane) that is likely to indicate the real address of this user.

A further example of applying the rule engine to HFTP 28 is in detecting a mismatch between shopping patterns and the outbound money flow from a given bank account. For example, money laundering may be suspected if the telecom profile of a given user indicates that the user shows high interest in luxury assets (e.g., by actively searching the Internet for such products), but the financial profile indicates that this user is thrifty (i.e., does not make expensive purchases).

### System Description

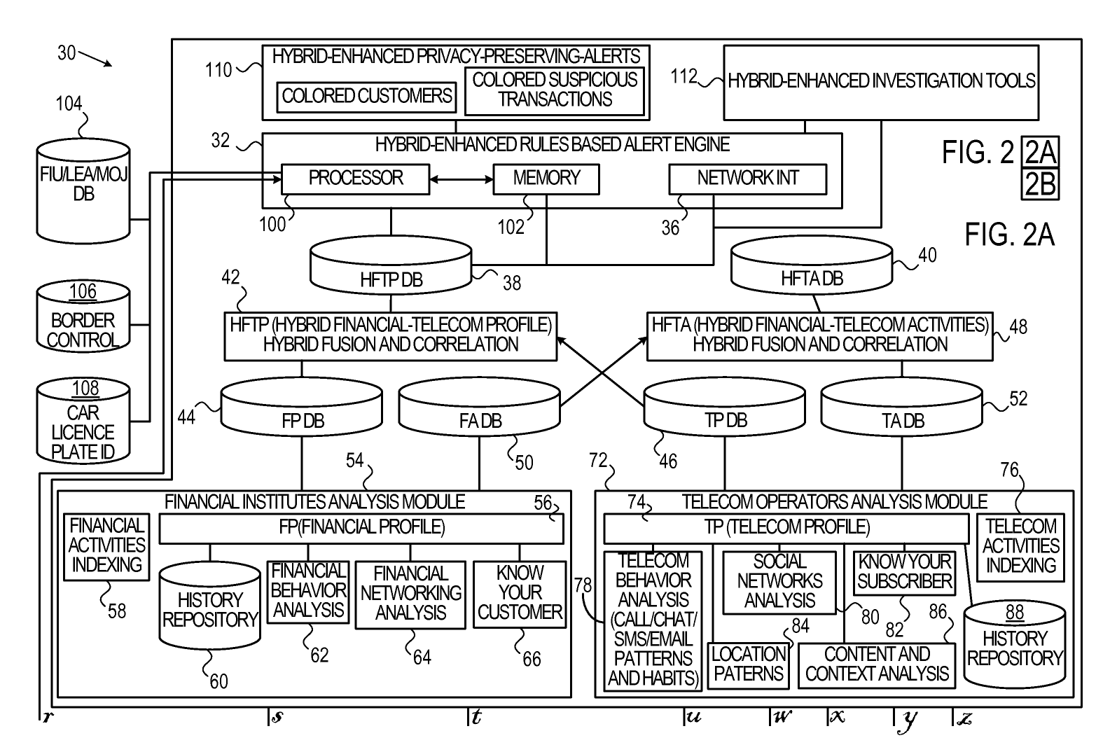

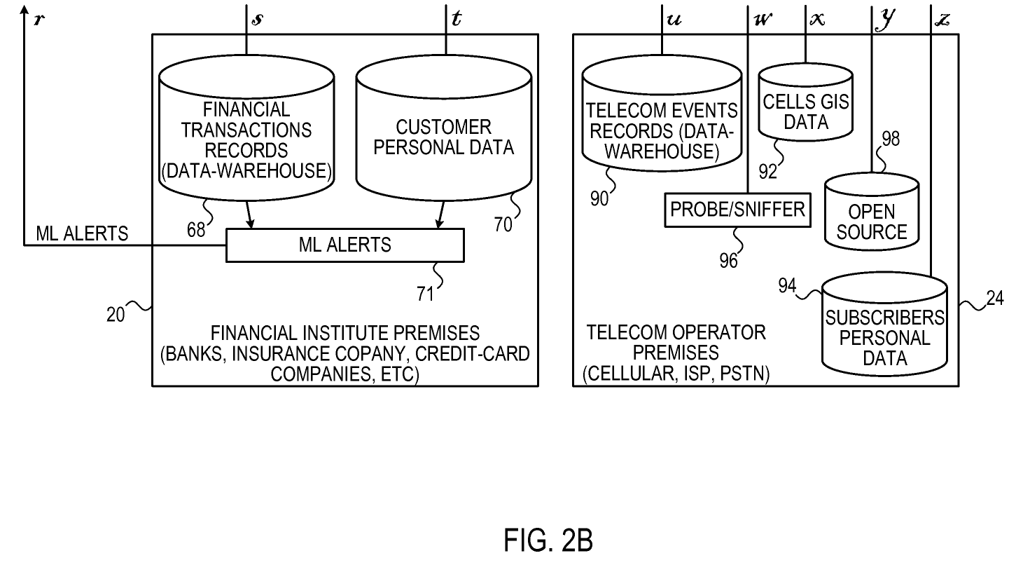

FIG. 2 is a block diagram that schematically illustrates a financial crime detection system 30, in accordance with an embodiment of the present disclosure. System 30 identifies and acts upon relationships between financial-plane indications and telecom-plane indications. System 30 comprises a rules-based alert engine 32. Alert engine 32 comprises a network interface 36, which receives indications regarding financial transactions and communication events related to users. The indications of the financial transactions originate from financial plane 20, while the indications of the communication events originate from telecom plane 24. In the example of FIG. 1, interface 36 receives user profile data from a HFTP database system 38 and user transaction data from a hybrid Financial-Telecom Activity (HFTA) database system 40.

System 30 comprises a HFTP module 42, which holds a hybrid profile similar to HFTP 28 described in FIG. 1 above. Module 42 fuses and correlates user profile information from a Financial Profile (FP) database 44 and a Telecom Profile (TP) database 46. HFTP module 42 stores the correlated profile information to a HFTP database 38. A HFTA module 48 fuses and correlates user activity information from a Financial Activity (FA) database 50 and a Telecom Activity (TA) database 52. HFTA module 48 stores the correlated activity information to HFTA database 40.

FP database 44 and FA database 50 receive updates from a financial institution analysis module 54. Module 54 comprises a Financial Profile (FP) module 56, which updates database 44, and a Financial Activities (FA) indexing module 58, which updates database 50. FA index module 58 labels and indexes the different subscriber transactions, enhancing search, access and categorization of the transactions.

FP module 56 defines a financial profile for each user, and comprises a history repository 60, a financial behavior analysis module 62, a financial networking analysis module 64, and a know-your-customer module 66. While FP database 44 stores the current financial user profiles, history repository 60 stores previous instances of the financial user profiles.

Financial behavior analysis module 62 stores financial user transaction information, such as transaction patterns, finance habits and transaction means (e.g., cash or wire transactions). Financial networking analysis module 64 identifies individuals, organizations and communities having financial relationships with the user. Know-your-customer module 66 determines the user's financial risk and analyzes user personal details for demographic categorization and socioeconomic analysis. In some embodiments, FP module 56 continually refines and updates the financial profiles in database 44 based on updates from modules 62, 64 and 66.

Financial institution analysis module 54 receives the indications of financial transactions from financial plane 20. The financial plane data sources are typically located at the relevant financial institutions. Financial institutions may comprise, for example, banks, insurance companies, credit card companies, stock brokers or any other suitable type of financial institution. System 20 may receive and act upon indications from any desired number of financial institutions. Typically, module 56 is connected via suitable interfaces to the computing systems of the financial institutions. In alternative embodiments, the financial data may be concentrated in a single location, such as at a Ministry of Justice (MOJ) database.

In the present example, the data sources of a given financial institution comprise a transaction data warehouse 68 and a user data repository 70. Transaction data warehouse 68 stores the financial transactions for the different users. User data repository 70 stores personal data of the financial institution's users, such as account number, address, identification, cellular phone number, email address, credit card number and family status. In some embodiments, a given financial institution may operate a Money Laundering (ML) alerts module 71, which generates alerts indicating suspected ML activities. Naturally, the alerts generated by module 71 are based only on information accessible to the specific financial institution. In some embodiments, rule engine 32 may use these alerts as an additional input.

Returning to the processing of communication events: TP database 46 and TA database 52 receive updates from a telecom operators analysis module 72. Module 72 comprises a TP module 74 that updates TP database 46, and a TA indexing module 76 that updates TA database 52. Module 76 labels and indexes the different user transactions, enhancing search, access and categorization of the transactions.

TP module 74 defines a telecom profile for each target user. Module 74 comprises a telecom behavior analysis module 78, a social networks analysis module 80, a know-your-subscriber module 82, a location patterns module 84, a context and context analysis module 86, and a history repository module 88. While TP database 46 stores the current telecom user profiles, history repository 88 stores previous instances of the telecom user profiles. Telecom Behavior analysis module 78 stores telecom user behavior, including call patterns (e.g., incoming/outgoing calls), communication habits, methods of communication (e.g., SMS, call, chat, e-mail, Twitter™, Facebook™, and Skype™).

Social networks analysis module 80 analyzes entities with which the subscriber has a communication relationship. Entities may comprise, for example, individuals, organizations or communities. Communication relationships may comprise, for example, calls, chats, emails, SMS or any other suitable communication interaction. In some embodiments, module 80 may base its analysis on open source intelligence (OSINT). Social network analysis is an important component in financial crimes investigation, since it may identify the path that the funds take during the money laundering process. Identified key nodes in the social network can be identified and investigated.

Know-your-subscriber module 82 analyzes personal details of telecom users to determine factors such as demographic consideration and socioeconomic indicators. Location patterns module 84 performs statistical analyses of telecom user physical location, as well as any time patterns for communication (e.g., time, day and week). Content and context analysis module 86 defines a profile for each telecom user by analyzing details such as voice calls, emails, chat, SMS communications, accessed web pages and wireless application protocol (WAP) pages. In some embodiments, telecom operators analysis module 72 continually refines and updates the telecom profiles in TP database 46 based on updates from modules 78, 80, 82, 84 and 86.

Telecom operator Analysis module 72 receives the indications of communication events from telecom plane 24. The telecom plane data sources are typically located at the relevant telecom operators. Such operators may comprise, for example, cellular telephone operators, Public Switched telephone Network (PSTN) operators, Internet service Providers (ISPs) or any other suitable type of operators. System 30 may receive and act upon indications from any desired number of operators. Typically, module 72 is connected via suitable interfaces to the computing systems and/or backbone networks of the telecom operators.

In the present example, the data sources for a given operator comprise a telecom event data warehouse 90, a cellular Geographic Information System (GIS) repository 92, a subscriber personal data repository 94, a probe/sniffer module 96 and an open source repository 98. For cellular operators, telecom event data warehouse 90 may store information such as Call Detail Records (CDRs), subscriber cellular ID locations, SMS records and Packet-Switched (IP) records. For a PSTN operator, data warehouse 90 may store CDRs. For an ISP, data warehouse 90 may store Internet Protocol (IP) records.

For a cellular operator, GIS repository 92 stores GIS data from CDRs, which can then be translated into geographic coordinates. Subscriber personal data repository 94 stores personal data of the subscribers of the given telecom operator. The data stored in repository 94 may comprise, for example, e-mail addresses, telephone numbers (i.e., land line and cellular), subscriber address, identification (e.g., social security number), credit-card numbers, bank account details and family information (e.g., marital status, number of children).

Probe/sniffer module 96 enhances the monitored data from telecom plane 24 by revealing detailed content information of communications such as SMSs (e.g., the text itself), e-mail content, visited web pages (e.g., domains of interests, Internet search engine requests, Internet chats, and/or interaction on social networks such as Facebook™ and Twitter™). Open source repository 98 stores data gathered from communication on public web sites (e.g., Facebook™ and Twitter™)

Returning to alert engine 32, rules used by the rule engine are stored in a memory 102. A rule processor 100 retrieves the rules from memory 102, and applies the rules to the hybrid profiles in HFTP database 38 and to the correlated activity information stored in HFTA database 40. Each rule tests a forensic criterion, which is defined over (1) the indications of the financial transactions obtained from financial plane 20, and (2) the indications of the communication events obtained from telecom plane 24.

Rule engine 32 may use various types of rules and forensic criteria. Rules may be defined during system initialization and/or added or modified during execution. Rule addition or modification may be performed manually by an operator, or automatically by an analytic (or artificial intelligence) application executing on processor 100. In some embodiments, alert engine 32 accesses data from various external data sources such as governmental agencies, as additional inputs. In the embodiment shown in FIG. 2, alert engine 32 retrieves data from a Law Enforcement Agency (LEA), Ministry of Justice (MOJ) or Financial Intelligence Unit (FIU) repository 104, a border control repository 106, and a Department of Transportation (DOT) repository 108 storing data on car registrations and driver licenses. Additionally or alternatively, any other suitable database or system can also be used as a data source.

If rule processor 100 identifies that a certain forensic criterion is met, the rule processor generates an alert. In some embodiments, the alerts are segregated based on data privacy level. For example, alert engine 32 can send alerts to a privacy preserving alert system 110, where financial institution representatives can view the alert without compromising user privacy. Additionally or alternatively, the alert engine can send alerts to an investigation system 112 for further investigation. Access to investigation system 112 may be restricted to government agencies (e.g., a LEA or FIU), who have authority to directly access the different databases of system 30 to assist in their investigations. In some implementations, an alert regarding a certain target user can only be sent to system 112 if a warrant was issued for this target user. A warrant can be issued, for example, in response to an alert from module 71 at a given financial institute.

Typically, rule processor 100 comprises a general-purpose computer, which is programmed in software to carry out the functions described herein. The software may be downloaded to the computer in electronic form, over a network, for example, or it may, alternatively or additionally, be provided and/or stored on tangible media, such as magnetic, optical, or electronic memory. The system configuration shown in FIG. 2 is an example configuration, which is shown purely for the sake of conceptual clarity. In alternative embodiments, any other suitable configuration can also be used. The functions of system 30 may be integrated with various other storage and analytics functions.

### Hybrid Profile Analysis Method Description

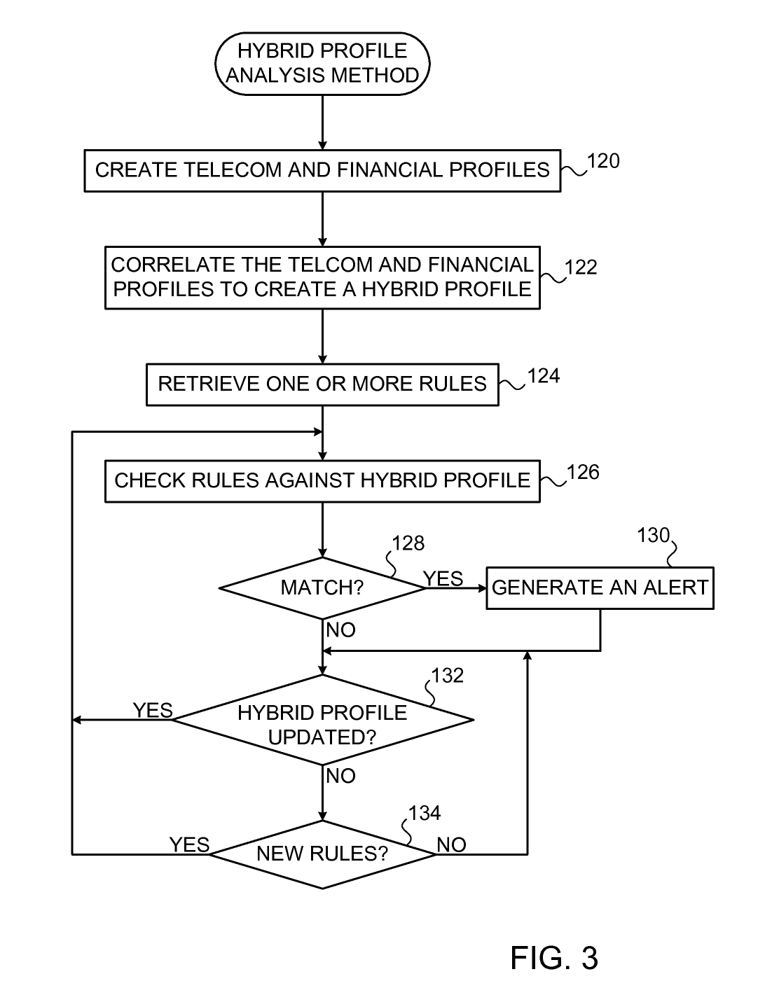

FIG. 3 is a flow diagram that schematically illustrates a method for detecting financial crimes, in accordance with an embodiment of the present disclosure. This method can be applied indiscriminately for all users, or for a designated group of target users. The mode of operation may be determined based on the applicable privacy regulations. For example, if the applicable regulations permit indiscriminate collection of data, then the method of FIG. 3 can be applied to all users. If, on the other hand, regulations permit data collection only after issuance of a warrant, then the method of FIG. 4 may be applied only for selected target users. The description that follows refers to a given target user, but the method can be applied similarly to any desired number of target user.

The method of FIG. 3 begins with financial institution analysis module 54 defining a financial profile of a certain target user, and telecom operator analysis module 72 defining a telecom profile of this target user, at a profiling step 120. HFTP module 42 correlates and fuses user profile data from financial profile database 44 and telecom profile database 46, so as to produce a Hybrid Financial-Telecom Profile (HFTP) of the target user. The HFTP is stored in HFTP database 38. Likewise, HFTA module 48 correlates and fuses user profile data from financial activity database 50 and telecom activity database 46 into HFTA database 40.

Rule processor 100 retrieves one or more rules from memory 102, at a rule retrieval step 124. The rule processor compares the retrieved rules against the hybrid profiles (HFTP and HFTA profiles), at a rule testing step 126. As noted above, each rule tests a forensic criterion, which is defined over the indications of financial transactions and communication events pertaining to the target user. If any of the rules are met, as checked at a rule checking step 128, rule processor 100 generates an alert, at an alert generation step 130. The alert may be transmitted to privacy preserving alert system 110 and/or investigation system 112.

Continuing in the method (i.e., either from step 128 or step 130), processor 100 checks whether the hybrid profiles (HFTP and HFTA profiles) have been updated, at a profile update checking step 132. If an update occurred, the method returns to step 126 above in order to check for rule matches. Finally, processor 100 checks whether any rules were added or modified in memory 102, at a rule update checking step 134. If a rule update occurred, the method returns to step 126. Otherwise, the method returns to step 132.

The embodiments described herein refer mainly to detecting money laundering transactions. Alternatively, however, the disclosed techniques can be used to detect other kinds of financial crimes, such as fraud, based on financial transactions and communication events. The methods and systems described herein can be applied in real time, e.g., for detecting financial crimes as they occur. Additionally or alternatively, the disclosed techniques can be applied off-line to data that is stored in the different databases of system 30, such as for investigating past events or for establishing evidence.

Although the embodiments described herein refer mainly to individual target users of financial institutions and communication networks, the disclosed techniques can be used with various other types of entities, which may be related to one another. An entity may comprise, for example, a group of individuals, a communication terminal (e.g., a cellular phone or a computer), a group of terminals or even an entire organization. Other types of entities may comprise, for example, e-mail addresses, Web-sites, bank accounts or home addresses. In the embodiments described herein, relationships between entities are indicated by communication between the entities over a communication network. In alternative embodiments, any other suitable form of interaction between entities can be used as a relationship indication.

The corresponding structures, materials, acts, and equivalents of all means or steps plus function elements in the claims below are intended to include any structure, material, or act for performing the function in combination with other claimed elements as specifically claimed. The description of the present disclosure has been presented for purposes of illustration and description, but is not intended to be exhaustive or limiting to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

It is intended that the appended claims cover all such features and advantages of the disclosure that fall within the spirit and scope of the present disclosure. As numerous modifications and changes will readily occur to those skilled in the art, it is intended that the disclosure not be limited to the limited number of embodiments described herein. Accordingly, it will be appreciated that all suitable variations, modifications and equivalents may be resorted to, falling within the spirit and scope of the present disclosure.

1. A method, comprising:
receiving from a financial system first indications of financial transactions related to a target user;
receiving from a communication network second indications of communication events, which are related to the target user but are not directly related to any financial transactions;
evaluating in a computer a forensic criterion defined over the first and second indications; and
issuing an alert upon meeting the criterion.

2. The method according to claim 1, wherein evaluating the forensic criterion comprises detecting a financial crime event using the first and second indications.

3. The method according to claim 2, wherein the financial crime event comprises one of a money laundering event and a fraud event.

4. The method according to claim 1, wherein evaluating the forensic criterion comprises associating, based on the second indications, the target user with at least one financial transaction that is not related to the target user according to the first indications.

5. The method according to claim 1, wherein evaluating the forensic criterion comprises associating the target user with at least one other user based on the second indications.

6. The method according to claim 1, wherein evaluating the forensic criterion and issuing the alert comprise constructing, based on the first and second indications, a profile that indicates characteristic financial and communication activity of the target user, and issuing the alert upon detecting a deviation from the profile.

7. The method according to claim 1, wherein evaluation of the forensic condition is performed only following a trigger from the financial system indicating a suspected financial event related to the target user.

8. Apparatus, comprising:
an interface, which is configured to receive from a financial system first indications of financial transactions related to a target user, and to receive from a communication network second indications of communication events that are related to the target user but are not directly related to any financial transactions; and
a processor, which is configured to evaluate a forensic criterion defined over the first and second indications, and to issue an alert upon meeting the criterion.

9. The apparatus according to claim 8, wherein the processor is configured to detect a financial crime event by evaluating the forensic criterion.

10. The apparatus according to claim 9, wherein the financial crime event comprises one of a money laundering event and a fraud event.

11. The apparatus according to claim 8, wherein the processor is configured to associate, based on the second indications, the target user with at least one financial transaction that is not related to the target user according to the first indications.

12. The apparatus according to claim 8, wherein the processor is configured to associate the target user with at least one other user based on the second indications.

13. The apparatus according to claim 8, wherein the processor is configured to construct, based on the first and second indications, a profile that indicates characteristic financial and communication activity of the target user, and to issue the alert upon detecting a deviation from the profile.

14. The apparatus according to claim 8, wherein the processor is configured to evaluate the forensic condition only following a trigger from the financial system indicating a suspected financial event related to the target user.

15. A computer software product, comprising a computer-readable medium, in which program instructions are stored, which instructions, when read by a computer, cause the computer to receive from a financial system first indications of financial transactions related to a target user, to receive from a communication network second indications of communication events that are related to the target user but are not directly related to any financial transactions, to evaluate a forensic criterion defined over the first and second indications, and to issue an alert upon meeting the criterion.
